(19) United States
(12) Patent Application Publication
(10) Pub. No.: US 2007/0193639 A1
(43) Pub. Date: Aug. 23, 2007

(54) Three-way proportional pressure reducing control valve

(75) Inventors: Junjie Ling, Ningbo City (CN); Zhentao Weng, Ningbo City (CN); Bo Jin, Ningbo City (CN); Yingjun Xie, Ningbo City (CN)

Correspondence Address: HAMRE, SCHUMANN, MUELLER & LARSON, P.C., P.O. BOX 2902, MINNEAPOLIS, MN, 55402-0902, US

(73) Assignee: NINGBO HOYEA MACHINERY MANUFACTURE, Ningbo City (CN)

(21) Appl. No.: 11/789,861

(22) Filed: Apr. 26, 2007

Related U.S. Application Data
(63) Continuation-in-part of application No. PCT/CN05/01902, filed on Nov. 10, 2005.

(30) Foreign Application Priority Data
Nov. 12, 2004 (CN) 200410068080.0

(51) Int. Cl. F15B 13/044

(52) U.S. Cl. 137/625.65

(57) ABSTRACT

A three-way proportional pressure reducing valve includes a valve body and a cylindrical valve spool. Five chambers are formed between the valve body and the cylindrical valve spool, respectively a fifth chambers, a first chamber, a second chamber, a third chamber and the fourth chamber. The first chamber connected to a high pressure inlet port P, the second chamber connected to a oil port A and the third chamber connected to a low pressure outlet port T. A first control edge being fitted between the first chamber and the second chamber, a second control edge being fitted between the second chamber and the third chamber. A first passage being located between the fifth chamber and the second chamber for connecting the second chamber to the fifth chamber, a second passage being located between the fourth chamber and the third chamber for connecting the fourth chamber to the third chamber. The present invention mainly provides a three-way proportional pressure reducing valve which can be achieved to control arbitrary pressure course change between pressure P at the constant pressure source and the oil tank at zero pressure by two damping adjustable control edges and the pressure feedback means of the chamber. The aim of the present invention is to solve the technological problem of change-over only within two limit value of zero pressure and maximum pressure and unable to control the intermediate pressure, which exists in the technology now available.

### FIELD OF THE TECHNOLOGY

The present invention concerns a control valve, particularly a control reciprocating displacement valve with proportionally pressure reducing and high frequency up to 100 Hz. It can be used for controlling the operation of inlet and exhaust valves of various internal combustion engines so as to make them attain optimum operating condition.

### BACKGROUND OF THE TECHNOLOGY

A traditional electro-hydraulic three-way direction control valve is a variety of electro-hydraulic directional valve. It has three oil ports, respectively called a port P, a port A and a port T. One side of a cylindrical valve spool of the electro-hydraulic three-way directional valve is equipped with electromagnet, at the other side with spring. Normally in application the port A is connected to an executive component, for instance, a chamber of an operating hydraulic cylinder, the spool of electro-hydraulic three-way directional valve by alternative action of a electromagnet and a spring moves over from one extreme position to the other, performing reciprocating movement. This operation can change open/close state between oil ports. If the cylindrical valve spool is situated at a certain extreme position, the port A and the port T open through, then the internal pressure is zero; when it is changed over to the other extreme position, the port A and the port P open through, then the internal pressure is high pressure P so as to push the executive component operating. If an electro-hydraulic four-way direction control valve blocks up an oil port of the four, it also can be used as the three-way direction control valve.

In operation, there are two states for the pressure at the port A of the electro-hydraulic three-way direction control valve: When the electromagnet is switched off, the port A and the port T open through, so the pressure at the port A is equal to that at the port T, then the pressure is minimum; when the electromagnet is switched on, the port A and the port P open through, so the pressure at the port A is equal to that at the port P, then the pressure is maximum. However, it is unable arbitrarily to take a pressure value between minimum and maximum values and keep a certain time at the port A for the existing electro-hydraulic three-way direction control valve, that is to say, the existing technology can settle direction-changing qualitative control, but cannot settle the midcourse control of pressure variation quantitative. In particular, it cannot get with control for the inlet and exhaust valves in a internal combustion engine, for at that time, it needs to attain direction-changing-over control necessary for the valve to make reciprocating movement and perform the control of the movement velocity and acceleration for the valve displacing. And this kind of control is quantitative, which must meet the requirement of “Pressure Displacement” control at the given mathematical function.

### SUMMARY

The present invention mainly provides a three-way proportional pressure reducing valve, which is simple in construction and reasonable in design. It can be achieved to control arbitrary pressure course change between the constant pressure source and the oil tank pressure at zero, it can be adjusted by a first and second control edges and the pressure feedback means of a chamber. The aim of the present invention is to solve the technological problem of change-over only within two limit values of zero pressure and maximum pressure and unable to control the intermediate pressure, which exists in the technology now available.

The above described technological problem is to be solved mainly through the technological project described below:

A three-way proportional pressure reducing control valve, including:

a valve body having a first and a second end,

a cylindrical valve spool aperture being located in the valve body, the cylindrical valve spool aperture having a plurality of under-cut grooves,

a cylindrical valve spool being located in the cylindrical valve spool aperture, the cylindrical valve spool being equipped with at least one shoulder, wherein an external diameter of the shoulder is equal to that of an inner diameter of the cylindrical valve spool aperture,

the valve body having three openings, including a high pressure inlet port P connected with a pump source, an oil port A connected with an executive component, and a low pressure outlet port T connected with an oil tank,

a plurality of chambers formed in the valve body between the cylindrical valve spool and the cylindrical valve spool aperture, the plurality of chambers including a first chamber connected to the high pressure inlet port P, a second chamber connected to the oil port A and a third chamber connected to the low pressure outlet port T, the second chamber being located between the first chamber and the third chamber,

a first control edge being fitted between the first chamber and the second chamber,

a second control edge being fitted between the second chamber and the third chamber,

a proportional force signal device being located at the first end of the valve body,

a fourth chamber being located at the first end of the valve body,

a fifth chamber being located at the second end of the valve body,

a first passage being located between the fifth chamber and the second chamber for connecting the second chamber to the fifth chamber, a second passage being located between the fourth chamber and the third chamber for connecting the third chamber to the fourth chamber, and

a notch providing damping being located on the first control edge and the second control edge.

Connecting the fifth chamber with the second chamber and the fourth chamber with the third chamber make the electromagnetic force acting on the cylindrical valve spool with the pressure of the oil chamber form a closed loop feedback thereby automatically adjust the pressure of the port A by means of external electromagnetic force. The notch opening at the control edge provides the damping, which not only adjusts the differential pressure between the port A and the port P but also increases the stability and the resolution factor of the control valve. The said notch can be triangle, also can be ladder shape, etc., for purpose of providing a non-linear damping for liquid flowing.

There is different damping when the cylindrical valve spool has displacement, because the liquid in two adjacent chambers exists flowing differential pressure, thus the pressure value at the low pressure end becomes different one. This different pressure value transfers pressure to the fifth chamber through the first passage connecting the fifth chamber and the second chamber, then the pressure of the fifth chamber immediately feedbacks to the proportional force signal device being located at the first end of the valve body Since both pressure are different, the cylindrical valve spool displaces until it reaches a new balance position, however the damping of the first control edge at the new balance position will be different, the pressure value at the low pressure end is different value, thus move in cycles, the pressure value at low pressure end (that is the second chamber ) changes continuously according to the setting demand.

For the a cylindrical valve spool, alloy steel or tool steel can be adopted, and for the material of the valve body casting iron or high strength aluminum can be used as raw material.

There is more than one shoulder as optimization. The cylindrical valve spool has two shoulders including a first shoulder and a second shoulder and a first under-cut groove, a second under-cut groove and a third under-cut groove, the first shoulder is adjacent to the fifth chamber, the second shoulder is adjacent to the fourth chamber, the first and second control edges are respectively constituted by annular end surfaces of the first and the second shoulders and corresponding sides of the under-cut groove; the first chamber is formed by the first shoulder and the first under-cut groove, the third chamber is formed by the second shoulder and the third under-cut groove, the second chamber is formed by a space between the cylindrical valve spool and the valve body that are located between the first chamber and the third chamber. The first chamber and the third chamber formed by the shoulder and the under-cut groove, so the first and the third chamber are circular ring shape. For the first and second control edges, there are three kinds of opening state: zero opening, positive opening and negative opening, the concrete condition depends on the requirement of the performance of the control valve.

As optimization, the cylindrical valve spool has three shoulder including a right shoulder, a left shoulder and a middle shoulder and a first under-cut groove, a second under-cut groove and a third under-cut groove the right shoulder is adjacent to the fourth chamber. The left shoulder is adjacent to the fifth chamber, the middle shoulder is located in the middle of the cylindrical valve spool. The first and second control edges are respectively composed of both side end surfaces of the middle shoulder and corresponding side edges of the second under-cut groove, the second chamber is formed by a space between the middle shoulder and the second under-cut groove, the third chamber is formed by a space between the cylindrical valve spool and the valve body that are located between the left shoulder and the middle shoulder, the first chamber is formed by a space between the cylindrical valve spool and the valve body that are located between the middle shoulder and the right shoulder.

As optimization, the said proportional force signal device is an electromagnet, a torque motor or an electrical-mechanical converter.

The fourth chamber can be equipped with the spring, and also can be not equipped with the spring, the spring force can be substituted by gravity by means of placing the valve body vertically. As optimization, the fourth chamber includes a spring, one end of the spring is contacted to an end surface of the cylindrical valve spool. Fitting with the spring in the fourth chamber can ensure that the movement of the cylindrical valve spool becomes much more stable.

The first passage can be situated at the cylindrical valve spool, the valve body or made as a connecting piece via external pipe. As optimization, the first passage is situated at the cylindrical valve spool, that is constituted by a horizontal transverse passage and a vertical passage perpendicular to the horizontal transverse passage, the horizontal transverse passage and the vertical passage are T shaped. It is convenient to be machined for being situated at the valve spool. This passage consists of the horizontal passage and the vertical passage so as to make uniform flowing speed of the pressure oil, decrease of the speed and even distribution of the pressure.

As optimization, the first passage is located on the valve body.

As optimization, the second passage is located on the cylindrical valve spool or the valve body.

Therefore, the present invention of three-way proportional pressure reducing control valve possesses the advantages described below: 1. the present invention of three-way proportional pressure reducing control valve can perform displacement adjustable reciprocating movement operation; 2. the inside of proportional electromagnet of present invention is at low pressure, so it is reliable in operation; 3. the present invention of three-way proportional pressure reducing control valve is applicable for the displacement adjustable reciprocating movement operation only by single stage, open-loop control, proportional adjustment, it needs not any position feedback, it is simple and reliable in the oil passage of its system and control circuit-; 4. the present invention of three-way proportional pressure reducing control valve has not any attached flow loss because only one control edge of the first and second control edges operates at all times in operation; 5. the present invention of valve body and cylindrical valve spool can be miniaturized, it is saving in materials, low in manufacturing cost and fine in economy.

### BRIEF DESCRIPTION OF THE DRAWINGS

FIG. 1 is the ensemble cut-away view of present invention of three-way proportional pressure reducing control valve with two shoulders;

FIG. 2 is the ensemble cut-away view of present invention of three-way proportional pressure reducing control valve with three shoulders;

FIG. 3 is the ensemble drawing of three-way proportional pressure reducing control valve (FIG. 1) applicable for the driving control of the internal combustion engine valve;

FIG. 4 is the ensemble drawing of three-way proportional pressure reducing control valve (FIG. 2) applicable for the driving control of the hydraulic cylinder;

FIG. 5 is the ensemble view of the cylindrical valve spool (FIG. 1);

FIG. 6 is the ensemble view of the cylindrical valve spool (FIG. 2)

### DETAILED DESCRIPTION

The following is the further concrete explanation for the present invention of technological project by means of implementation examples with attached drawings.

Implementation Example 1:

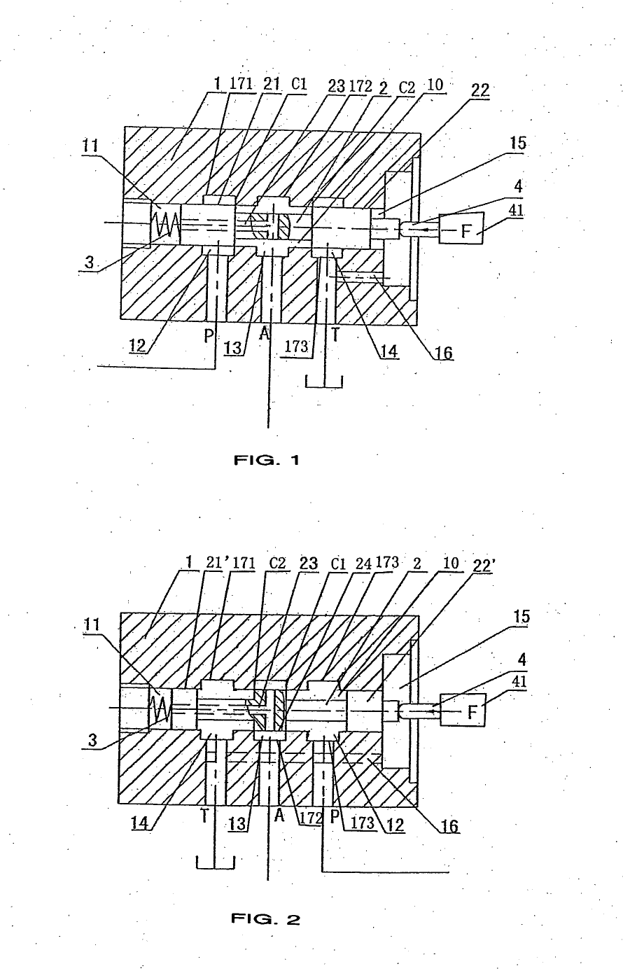

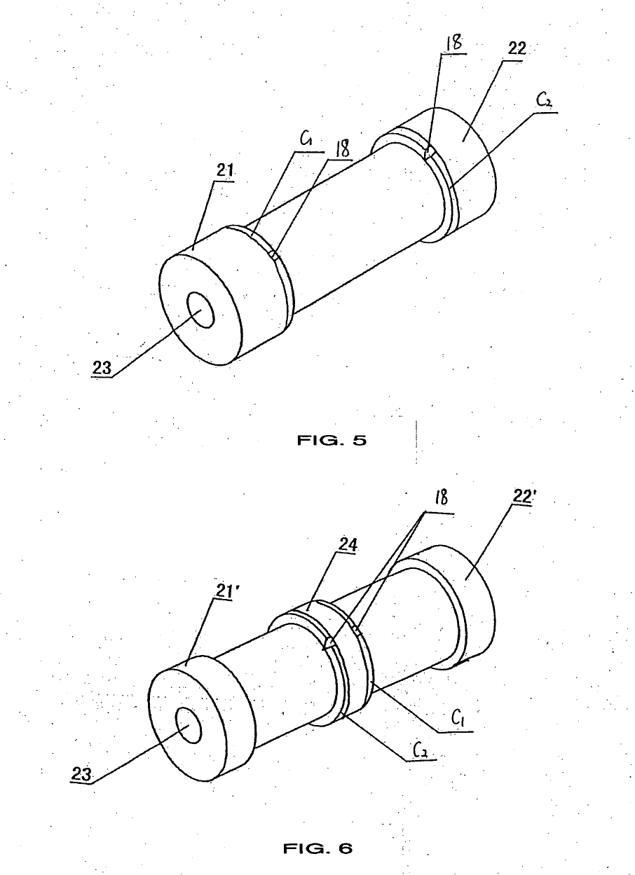

As shown in FIGS. 1 and 5, a three-way proportional pressure reducing valve including the valve body 1 made of casting iron, it has a first and second end, there is the cylindrical valve spool aperture 10 being located in the valve body 1, there are three ring-shaped under-cut grooves in the circumferential space of valve spool aperture 10,including the first under-cut groove 171, the second under-cut groovel72 and the third under-cut groove 173. The cylindrical valve spool 2 made of tool steel being located in the cylindrical valve spool aperture 10. In the circumference of cylindrical valve spool 2 there are the two ring-shaped shoulders, including first shoulder 21 and second shoulder 22, the outer diameter of the shoulder is equal to that of the inner wall of valve spool aperture 10. After having assembled the valve body 1 and the cylindrical valve spool 2, five chambers are formed between the cylindrical valve spool 2 and the valve spool aperture 10 thereof, successively from left to right the fifth chamber 11, the first chamber 12, the second chamber 13, the third chamber 14 and the fourth chamber 15. The first shoulder 21 is adjacent to the fifth chamber 11, the second shoulder 22 is adjacent to the fourth chamber 15, the first chamber 12 is formed by the first shoulder 21 and the first under-cut groove 171, the third chamber 14 is formed by the second shoulder 22 and the third under-cut groove 173, the second chamber 13 is formed by a space between the cylindrical valve spool 2 and the valve body 1 that are located between the first shoulder 21 and the third shoulder 22. The first control edge C1 and the second control edge C2 are respectively constituted by annular end surfaces of the first and the second shoulders and corresponding sides of an under-cut groove, The first control edge C1 and the second control edge C2 are ring edges. At the first and second control edges are uniformly set triangle notch 18 so as to provide variable damping.

The fifth chamber 11 includes a spring 3, one end of the spring 3 is contacted to an end surface of the cylindrical valve spool 2, the other end of the spring 3 is contacted to a spring seat 31 which is contacted to the seal of the second end of the valve body 1 so as to make the cylindrical valve spool 2 have the tendency to displace toward right side all the time. In the fourth chamber 15 is located a crown bar 4 of the electromagnet 41. The crown bar 4 is throughout contacted with the right end surface of the cylindrical valve spool 2. The second chamber 13 is all along situated between the first chamber 12 and the third chamber 14. The first chamber 12 is the high pressure source connecting with the oil pump, the third chamber 14 is the zero pressure source connecting with the oil tank, the second chamber 13 is the chamber to produce the necessary working pressure.

At the bottom surface of the valve body 1 there are openings, respectively a pressure inlet port P connected with pump source, an oil port A connected with any executive components and a low pressure outlet port T connected with the oil tank. The first chamber 12 connected to the high pressure inlet port P, the second chamber 13 connected to the oil port A and the third chamber 14 connect to the low pressure outlet port T.

A first passage 23 is situated at the cylindrical valve body 2 for connecting the second chamber 13 to the fifth chamber 11, the first passage 23 is constituted by a horizontal transverse passage and a vertical passage perpendicular to the horizontal transverse passage, the horizontal transverse passage and the vertical passage are T shaped. The fourth chamber 15 is connected with the third chamber 14, the fifth chamber 11 is connected with the second chamber 13. A second passage 16 is situated at the valve body 1 for connecting the third chamber 14 to the fourth chamber 15.

When the electromagnet 41 is under natural condition (i.e. in initial state), the input current of the electromagnet 41 is zero. Due to the combined action of the recompression of the spring 3 and the residual pressure of the second chamber 13 which is caused by the leakage existing from the first chamber 12 to the second chamber 13, the cylindrical valve spool 2 is pushed to first end of the valve body 1 so as to make the first control edge C1 being closed, the second control edge C2 being opened and the oil pressure of the second chamber 13 becoming zero.

In operation, the electromagnet 41 of the three-way proportional pressure reducing valve is energized with fixed current, the electromagnetic thrust F in proportion to the current is produced on the electromagnet 41. The electromagnetic thrust F overcomes the acting force of the spring 3 to make the cylindrical valve spool 2 displace toward the side of the fifth chamber 11 thereby make the first control edge C1 being opened and the second control edge C2 being closed, at that time the pressure oil flows into the oil port A after it has successively passed through the high pressure inlet port P, the first chamber 12, the first control edge C1, the second chamber 13, then the high pressure inlet port P is communicated with the oil port A and a pressure P_{A} of the oil port A increases. At the same time, the pressure P_{A} passes to the fifth chamber 11 through the first passage 23 of the cylindrical valve spool 2 and acts on the left end surface of the cylindrical valve spool 2, this force for the electromagnet 41 is feedback acting force. Under joint action of the feedback acting force and the spring 3, the speed of the cylindrical valve spool 2 displacing to the fifth chamber 11 is decreased. When the pressure P_{A} of the oil port A increases to be equal to the electromagnetic thrust F, the cylindrical valve spool 2 reaches up to a dynamic balance.

The adjusting procedure for the balance position of the cylindrical valve spool 2 is automatically realized. The movement of the cylindrical valve spool 2 stands the joint action of the control the port pressure, a spring force, the electromagnetic thrust and a friction. Its balance position is satisfied to the equation below:
πd²P_{A}/4+Fₛ=F+F_{f} that is:P_{A}=4(F+F_{f}−Fₛ)/πd²

Where: d—diameter of the cylindrical valve spool
P_{A}—pressure of chamber A
Fₛ—spring force
F—electromagnetic thrust
F_{f}—friction

The spring force is much smaller than the electromagnetic thrust because the selected the spring 3 possesses not large elastic force, and a friction usually is much more smaller than the electromagnetic one. Since the electromagnetic thrust is in proportion to the input current signal of the electromagnet 41, the adjustment in a certain sense results in realizing the control of the pressure P_{A} of the control port in proportion to the input current signal.

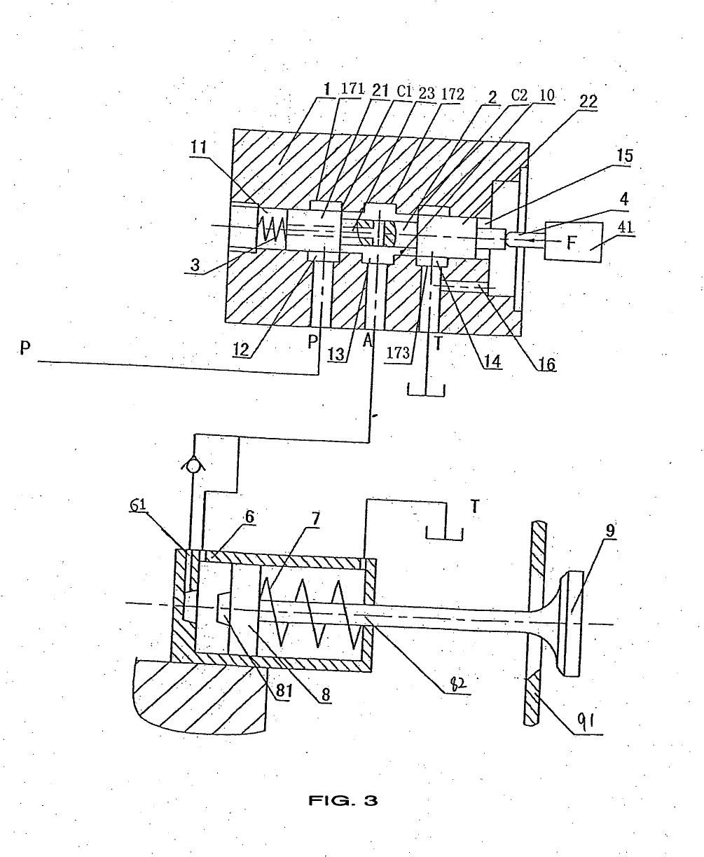

As shown in FIG. 3, when the three-way proportional pressure reducing control valve used for the valve control of the internal combustion engine, the variation of pressure P_{A} of oil port A will be directly applied on the left chamber of a oil cylinder 6 with the change of the electrical signal, because the oil port A of the three-way proportional pressure reducing control valve is connected with the left chamber of the oil cylinder 6 through a oil inlet pipe 61, and a right chamber of the oil cylinder 6 is directly connected with a oil return tank. If the pressure P_{A} of the oil port A increases, a spring 7 is gradually compressed, a piston 8 moves to the right chamber of the oil cylinder 6 to carry a valve head 9 to move to the right via a piston rod 82 until the pressure P_{A} of the oil port A is balance with the acting force of the spring 7. Similarly, if the pressure P_{A} of the oil port A decreases, the piston 8 moves to the left chamber of the cylinder at the acting force of the recovery force of the spring 7 to carry the valve head 9 to move toward the left until the resultant force and the recovery force of the spring 7 are balance. In the above mentioned two kinds of balance state, the piston 8 is static without any motion, a corresponding space is obtained between the valve head 9 and a valve seat 91.

If in the above mentioned dynamic balance state, the electromagnetic thrust F of the electromagnet 41 increases when the current signal increases. The electromagnetic thrust F pushes the cylindrical valve spool 2 to move toward the fifth chamber 11 so as to make the opening of the first control edge C1 enlarge, then the pressure P_{A} of the oil port A rises which acts on the left end surface of the cylindrical valve spool 2 through a oil hole 23 of the cylindrical valve spool 2 to push the cylindrical valve spool 2 move toward the fourth chamber 15. Finally, it gets another dynamic balance with the electromagnetic thrust F. Meanwhile, the pressure of the left chamber of the oil cylinder 6 also increases with it to overcome the acting force of the spring 7 so as to make the piston 8 move toward the right chamber of the oil cylinder 6 until it sets a new balance with the spring 7, then the piston 8 is in static state again, and correspondingly suitable space is also obtained between the valve head 9 and the valve seat 91.

Conversely, in the above described dynamic balance state, the electromagnetic thrust decreases with the decrease of the current signal of the electromagnet 41, then the cylindrical valve spool 2 at the action of the pressure P_{A} carries the first and second shoulders 21,22 move toward the fourth chamber 15 so as to make the opening of the first control edge C1 smaller, and the pressure P_{A} of the oil port A also decreases with it. The pressure P_{A} after decreased acts on the left end of the cylindrical valve spool 2 so as to make the cylindrical valve spool 2 stop moving toward the fourth chamber 15. Finally, it gets dynamic balance again with the electromagnetic thrust F. Meanwhile, the pressure of the left chamber of the cylinder 6 is also caused to decrease. At the action of the recovery force of the spring 7, the piston 8 moves toward the left chamber of the oil cylinder 6 until a new balance is established with the spring 7, the piston 8 then is again in static state without any motion, the correspondingly suitable space is obtained again between valve head 9 and valve seat 91.

Thus, the piston 8 moves left and right quickly with the change of the external electrical signal so as to make a corresponding opening obtained between the valve head 9 and the valve seat 91. If you want to make the valve close, you must let the current of the proportional electromagnet 41 suddenly drop down to zero or smaller initial value, the acting force at the end of the cylindrical valve spool 2 facing the electromagnet 41 disappears, then at the action of a reset spring, there is still a certain pressure in the left chamber of the cylinder 6, the second chamber 13 of three-way proportional pressure reducing control valve and the fifth chamber 11. At the action of this pressure, the cylindrical valve spool 2 promptly moves to the electromagnet 41 so as to make the first control edge C1 being closed and the opening of the second control edge C2 be maximum, the resistance for removing the oil from the left chamber of the cylinder 6 be minimum, thus the valve can be promptly closed.

Implementation Example 2:

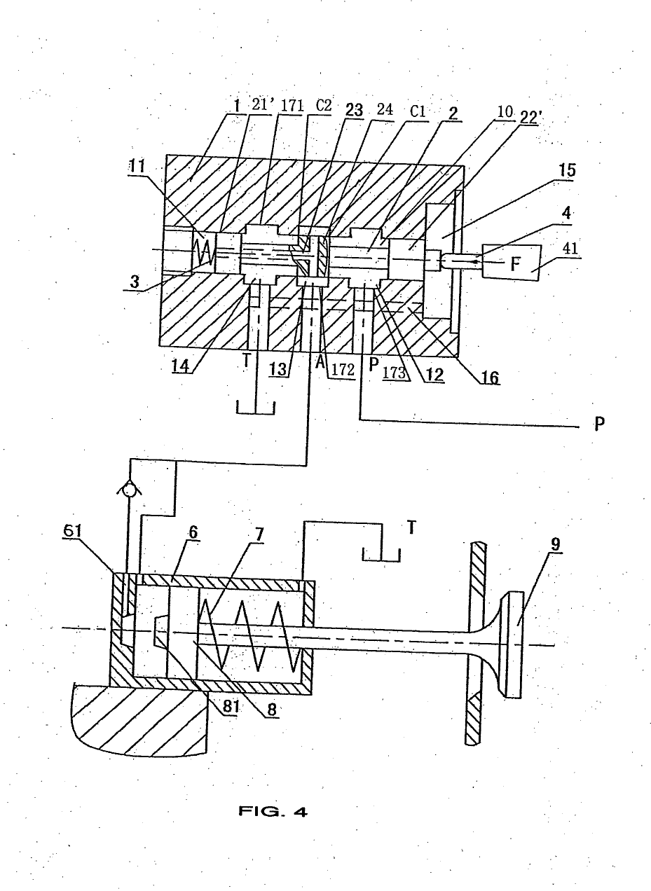

As shown in FIGS. 2, 4 and 6, the three-way proportional pressure reducing control valve contains the valve body 1 made of high strength aluminum. In the valve body 1 is located the cylindrical valve spool aperture 10. At the circumference of the valve spool aperture 10 is set three ring-shaped under-cut grooves 17, including the first under-cut groove 171, the second under-cut groove 172 and the third under-cut groove 173. In the cylindrical valve spool aperture 10 is seated the cylindrical valve spool 2 made of alloy steel which also is cylindrical shape. At the circumference of the cylindrical valve spool 2 there are three ring-shaped shoulders, including a right shoulder 22′ a left shoulder 21′ and a middle shoulder 24, the external diameter of the shoulders is equal to the inner wall diameter of the cylindrical valve spool aperture 10. The right shoulder 22′ is adjacent to the fourth chamber 15, the left shoulder 21′ is adjacent to the fifth chamber 11, the middle shoulder 24 is located in the middle of the cylindrical valve spool 2, the first control edge C1 and second control edge C2 are respectively composed of both side end surfaces of the middle shoulder 24 and corresponding side edge of the second under-cut groove 172. Between the cylindrical valve spool 2 and the cylindrical valve spool aperture 10 five chambers are formed successively from left to right: the fifth chamber 11, the third chamber 14, the second chamber 13, the first chamber 12 and the fourth chamber 15. The second chamber 13 is formed by a space between the middle shoulder 24 and the second under-cut groove 172, the third chamber 14 is formed by a space between the cylindrical valve spool 2 and the valve body 1 that are located between the left shoulder 21′ and the middle shoulder 24, the first chamber 12 is formed by between the cylindrical valve spool 2 and the valve body 1 that are located between the middle shoulder 24 and the right shoulder 22′. The other constructions of the three-way proportional pressure reducing control valve are the same with the implementation 1.

Similarly, when the input current of the electromagnet 41 is zero, due to the combined action of the precompression of the spring 3 and the residual pressure of the second chamber 13 which is caused by a leakage existing from the first chamber 12 to the second chamber 13, the cylindrical valve spool 2 is pushed to the side of the electromagnet 41 so as to make the first control edge C1 being closed, the second edge C2 being opened and the pressure of the oil in the second chamber 13 become zero. The principle of the action is the same with the implementation example 1.

The protection range of the present invention is not restricted in the provided implementation examples

Even if some changes are made for the construction project of the implementation examples such as the electromagnet 41 is replaced by the toque motor or electric-mechanical converter; or the notch shape is changed for the control edges, the notch is set as a chute, squire or ladder-shaped etc. Thus with the movement of the cylindrical valve spool, the first control edge C1 and the second control edge C2 are formed between the chute notch, squire or trapeze notch and the valve body, or the above mentioned springs are removed or the oil hole is set at the outside of the valve body etc. This project still belongs to the protection range of the present invention.

1. A three-way proportional pressure reducing control valve, including:
a valve body having a first and a second end,
a cylindrical valve spool aperture being located in the valve body, the cylindrical valve spool aperture having a plurality of under-cut grooves,
a cylindrical valve spool being located in the cylindrical valve spool aperture, the cylindrical valve spool being equipped with at least one shoulder, wherein an external diameter of the shoulder is equal to that of an inner diameter of the cylindrical valve spool aperture,
the valve body having three openings, including a high pressure inlet port P connected with a pump source, an oil port A connected with an executive component, and a low pressure outlet port T connected with an oil tank,
a plurality of chambers formed in the valve body between the cylindrical valve spool and the cylindrical valve spool aperture, the plurality of chambers including a first chamber connected to the high pressure inlet port P, a second chamber connected to the oil port A and a third chamber connected to the low pressure outlet port T, the second chamber being located between the first chamber and the third chamber,
a first control edge being fitted between the first chamber and the second chamber,
a second control edge being fitted between the second chamber and the third chamber,
a proportional force signal device being located at the first end of the valve body,
a fourth chamber being located at the first end of the valve body,
a fifth chamber being located at the second end of the valve body,
a first passage being located between the fifth chamber and the second chamber for connecting the second chamber to the fifth chamber,
a second passage being located between the fourth chamber and the third chamber for connecting the third chamber to the fourth chamber, and
a notch providing damping being located on the first control edge and the second control edge.

2. The three-way proportional pressure reducing control valve according to claim 1, wherein the cylindrical valve spool has two shoulders including a first shoulder and a second shoulder and a first under-cut groove, a second under-cut groove and a third under-cut groove, the first shoulder is adjacent to the fifth chamber, the second shoulder is adjacent to the fourth chamber, the first and second control edges are respectively constituted by annular end surfaces of the first and the second shoulders and corresponding sides of the first and the second under-cut groove; the first chamber is formed by the first shoulder and the first under-cut groove, the third chamber is formed by the second shoulder and the third under-cut groove, the second chamber is formed by a space between the cylindrical valve spool and the valve body that are located between the first chamber and the third chamber.

3. The three-way proportional pressure reducing control valve according to claim 1, wherein the cylindrical valve spool has three shoulders including a right shoulder, a left shoulder and a middle shoulder and a first under-cut groove, a second under-cut groove and a third under-cut groove, the right shoulder is adjacent to the fourth chamber, the left shoulder is adjacent to the fifth chamber, the middle shoulder is located in the middle of the cylindrical valve spool, the first and second control edges are respectively composed of both side end surfaces of the middle shoulder and corresponding side edges of the second under-cut groove, the second chamber is formed by a space between the middle shoulder and the second under-cut groove, the third chamber is formed by a space between the cylindrical valve spool and the valve body that are located between the left shoulder and the middle shoulder, the first chamber is formed by a space between the cylindrical valve spool and the valve body that are located between the middle shoulder and the right shoulder.

4. The three-way proportional pressure reducing control valve according to claim 1, wherein the proportional force signal device is an electromagnet, a torque motor or an electric-mechanical converter.

5. The three-way proportional pressure reducing control valve according to claim 1, wherein the fifth chamber includes a spring, one end of the spring is contacted to an end surface of the cylindrical valve spool.

6. The three-way proportional pressure reducing control valve according to claim 1, wherein the first passage is situated at the cylindrical valve spool that is constituted by a horizontal transverse passage and a vertical passage perpendicular to the horizontal transverse passage, the horizontal transverse passage and the vertical passage are T shaped.

7. The three-way proportional pressure reducing control valve according to claim 5, wherein the first passage is situated at the valve spool, that is constituted by a horizontal transverse passage and a vertical passage perpendicular to the horizontal transverse passage, the horizontal transverse passage and the vertical passage are T shaped.

8. The three-way proportional pressure reducing control valve according to claim 1, wherein the first passage is located on the valve body.

9. The three-way proportional pressure reducing control valve according to claim 5, wherein the first passage is located on the valve body.

10. The three-way proportional pressure reducing control valve according to claim 1, wherein the second passage is located on the cylindrical valve spool or the valve body.

11. The three-way proportional pressure reducing control valve according to claim 7, wherein the second passage is located on the cylindrical valve spool or the valve body.

12. The three-way proportional pressure reducing control valve according to claim 9, wherein the second passage is located on the cylindrical valve spool or the valve body.
